(19) United States
(12) Patent Application Publication
(10) Pub. No.: US 2023/0030337 A1
(43) Pub. Date: Feb. 2, 2023

(54) Veilla Mask

(71) Applicant: Moses Villa, Ewa Beach, HI (US)

(72) Inventor: Moses Villa, Ewa Beach, HI (US)

(21) Appl. No.: 17/389,242

(22) Filed: Jul. 29, 2021

(51) Int. Cl. A41D 13/11; A62B 23/00; A62B 18/02

(52) U.S. Cl. CPC A41D 13/1153; A62B 23/00; A62B 18/02

(57) ABSTRACT

An article of manufacture for providing a combination personal protection device including a mask, a shield, and a veil is disclosed. The personal protection device includes a mask, a veil having a face opening and a pair of ear openings, a face shield having a mouth opening, a mouth flap configured to removably cover the mouth opening, a headband having an inner band coupled to the veil and an outer band coupled to the face shield. a crown support cap coupled to a top edge of the veil, and a crown air filter and a pair of ear air filters.

### TECHNICAL FIELD

This application relates in general to an article of manufacture for providing health safety devices, and more specifically, to an article of manufacture providing a one piece combination personal protection device including a mask, a shield, and a veil.

### BACKGROUND

The PPEs in use today have major shortcomings and drawbacks, reasons why we still have unexpected and uncontrollable outbreaks of the disease recurring even in the most strictly controlled quarantined areas and in spite of so much innovative, expensive, and complicate anti-infection control efforts and mechanisms that are being practiced today. The market needs a PPE design that gives users an almost complete 100% head wise protection particularly against COVID-19 and other similar airborne infections that no singular PPE of today can give and/or match its total benefits for simplicity, economy, convenience, and the superior protection it can give.

Therefore, a need exists for an article of manufacture for providing a combination personal protection device including a mask, a shield, and a veil. The present invention attempts to address the limitations and deficiencies in prior solutions according to the principles and example embodiments disclosed herein.

### SUMMARY

In accordance with the present invention, the above and other problems are solved by providing an article of manufacture providing a combination personal protection device including a mask, a shield, and a veil according to the principles and example embodiments disclosed herein.

In one embodiment, the present invention, described herein as VEILLA-MASK, is an article of manufacture for providing a combination personal protection device including a mask, a shield, and a veil. The personal protection device includes a mask, a veil having a face opening and a pair of ear openings, a face shield having a mouth opening, a mouth flap configured to removably cover the mouth opening, a headband having an inner band coupled to the veil and an outer band coupled to the face shield. a crown support cap coupled to a top edge of the veil, and a crown air filter and a pair of ear air filters.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates a front and side view an example embodiment of an article of manufacture for providing a combination personal protection device including a mask, a shield, and a veil according to the present invention.

FIG. 2 illustrates an exploded view of an article of manufacture for providing a combination personal protection device including a mask, a shield, and a veil according to the present invention.

FIG. 3 illustrates a front view of the VEILSPHERE with most of its integrated parts attached and shown being an article of manufacture for providing a combination personal protection device including a mask, a shield, and a veil according to the present invention.

FIGS. 4a-b illustrate front side view the VEIL alone without any of the integrated parts attached and shown being an article of manufacture for providing a combination personal protection device including a mask, a shield, and a veil according to the present invention.

FIG. 5 illustrates a set of crown and ear filter elements within an article of manufacture for providing a combination personal protection device including a mask, a shield, and a veil according to the present invention.

FIG. 6 illustrates a front and top view of a crown support caps used within an example embodiment of an article of manufacture for providing a combination personal protection device including a mask, a shield, and a veil according to the present invention.

FIG. 7 illustrates partial side views of a headband and face shield attaching to of an article of manufacture for providing a combination personal protection device including a mask, a shield, and a veil according to the present invention.

FIG. 8 illustrates a side view of the headband straps of the article of manufacture for providing a combination personal protection device including a mask, a shield, and a veil according to the present invention.

FIG. 9 illustrates a front view of a face shield with a mouth opening that is part of an article of manufacture for providing a combination personal protection device including a mask, a shield, and a veil according to the present invention.

FIG. 10 illustrates a front view of a face shield and mouth opening cover in front of the face shield which is part of a shield and mouth opening cover that is part of an example embodiment of an article of manufacture for providing a combination personal protection device including a mask, a shield, and a veil according to the present invention.

FIG. 11 illustrates a front view of a mouth opening cover or mouth flap that is part of an article of manufacture for providing a combination personal protection device including a mask, a shield, and a veil according to the present invention.

FIG. 12 illustrates a front view of shield tie that is part of an article of manufacture for providing a combination personal protection device including a mask, a shield, and a veil according to the present invention.

### DETAILED DESCRIPTION

This application relates in general a system and method for providing health safety devices, and more specifically, to an article of manufacture for providing a combination personal protection device including a mask, a shield, and a veil according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

The terms “individual,” and “user” refer to an entity, e.g., a human, using an article of manufacture providing a combination personal protection device including a mask, a shield, and a veil associated with the invention. The term user herein refers to one or more users.

The term “invention” or “present invention” refers to the invention being applied for via the patent application with the title “VEILLA Mask.” Invention may be used interchangeably with mask.

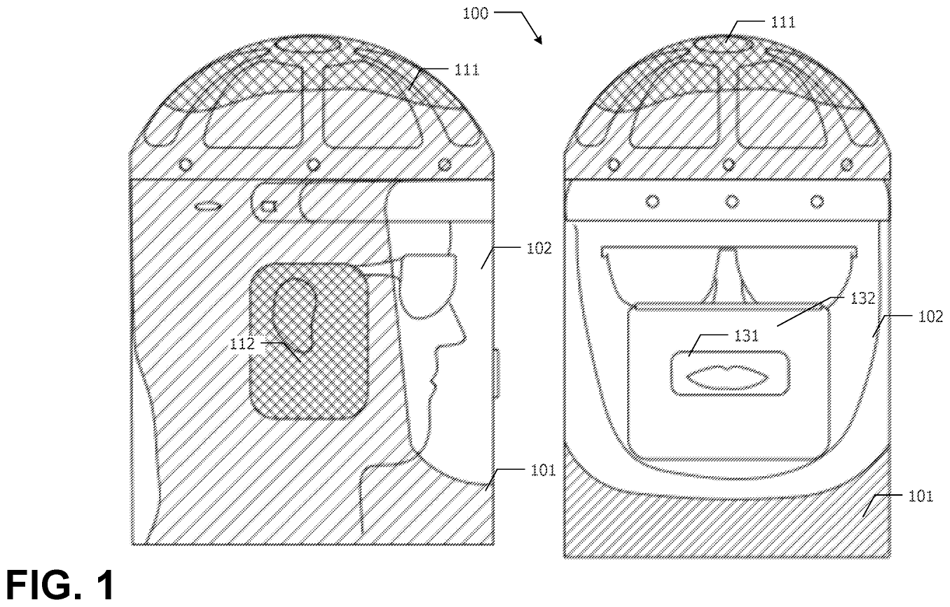

In general, the present disclosure relates an article of manufacture for providing a combination personal protection device including a mask, a shield, and a veil according to the present invention. To better understand the present invention, FIG. 1 illustrates a front and side view an example embodiment of an article of manufacture for providing a combination personal protection device including a mask, a shield, and a veil according to the present invention. The present invention as shown in FIG. 1 is a trio combination of three major parts: a VEIL 101, a FACE SHIELD 102, and a MASK 111,112a-b put together as a one complete no leakage protective piece against airborne infection. The VEIL 101 is a term for a one piece hood with openings made from a clear plastic sheet. The FACE-SHIELD 102 a clear transparent hard and flexible plastic material. The MASK refers to AIR FILTERS only a Crown air filter 111, and two Ear air filters 112a and 112b. The VEILSPHERE 100 it is an off-shoot of the veil after an integration of all parts, the Veil, Mask, Face-Shield Mouth Flap, Crown Support Cap, Headband, Straps and Drawstrings, etc. has been accomplished. Once all the other parts are joined and integrated into one, it is referred to as the VEILSPHERE. Obviously, the word resonates with encapsulating protection. The term VEILSPHERE 100 is used for most of the disclosure herein. The reference to VEILLA-MASK represents everything disclosed herein.

The VEILSPHERE has a pair of ear openings 203a and 203b fitted with ear filters 112a and 112b, a crown opening fitted with a crown filter 111/215, a mouth opening 131 on the Face-Shield 102 protected by a mouth flap 132 configured to removably cover the mouth opening 131, a headband 217 of fused inner 702 and outer 703 bands coupled to both the fused Veil 101 and the face shield, 102 a crown support cap 601, 602, and 605 coupled to the top edge of the veil 212 FIG.-2 that spread the crown filter 111/215 and also acts as a head protection device. Having the ability of three put into a one piece unit, it is more infallible. It encapsulates and protects the head, the most susceptible and vulnerable portion of our body against an infection specially COVID-19.

The face shield 102 includes a mouth flap 132 over a mouth access opening 131 to provide a barrier between an outside environment and a user. Air filters 111-112 are inserted within the veil 101 to allow an exchange of air between the inside of the veil about the user and the outside environment. Other components of the mask 100 are described in more detail in references to figures below.

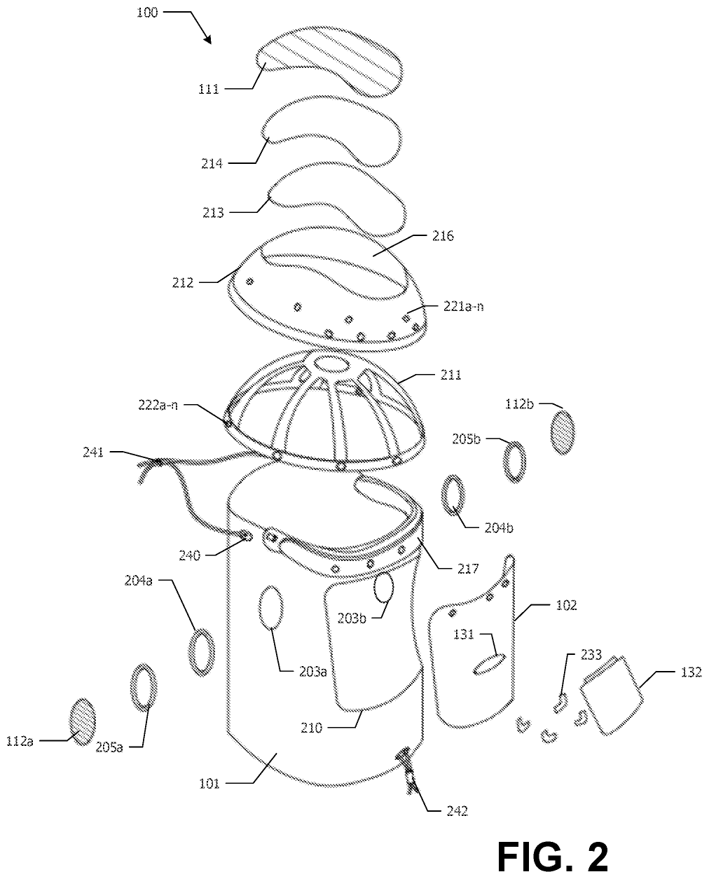

FIG. 2 illustrates an exploded view of an article of manufacture for providing a combination personal protection device including a mask, a shield, and a veil according to the present invention. The VEILSPHERE 100 is shown to be based upon a veil 101 having a face shield 102 covering a face of a user. The face shield 102 has a mouth access opening 131 that is covered by a mouth flap 132. The mouth flap 132 is sealed against the face shield 102 by a set of securing connections 233. The securing connections 233 may comprise mating pairs of Velcro™ located about the lower corners of the mouth flap 132.

The face shield 102 connects to the VEILSPHERE 100 by a pivoting headband 217 that pivots upward from its connection to the VEILSPHERE 100 to raise the face shield 102 out of the way of a user's face. A top portion of the VEILSPHERE 100 comprises an attached crown support cap 211 having female disc snaps 222a-n about its parameter for coupling to a crown 212. The crown uses a pair of mating Velcro™ seals 213-214 to secure the crown air filter 215 to a top opening 216 of the crown.

The VEILSPHERE 100 may also include a pair of ear openings 203a-b on opposite sides of the VEILSPHERE 100 to allow a user to hear sounds from within the outside environment. Each of the ear openings 203a-b are fitted with ear filters 112a-b having a pair of mating Velcro™ seals 204a-b, 205a-b to secure ear air filters 112a-b to the external side of the VEILSPHERE 100 over the ear openings 203a-b.

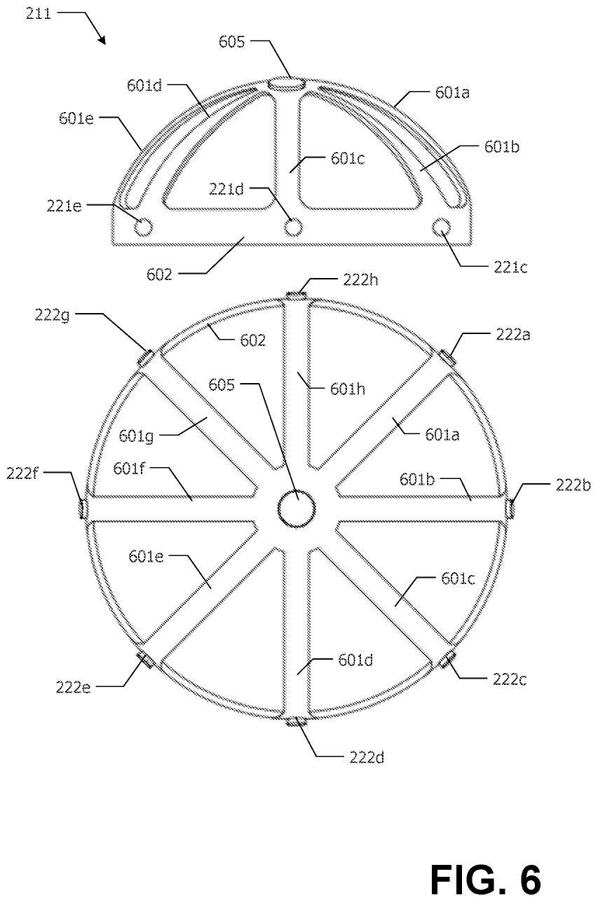

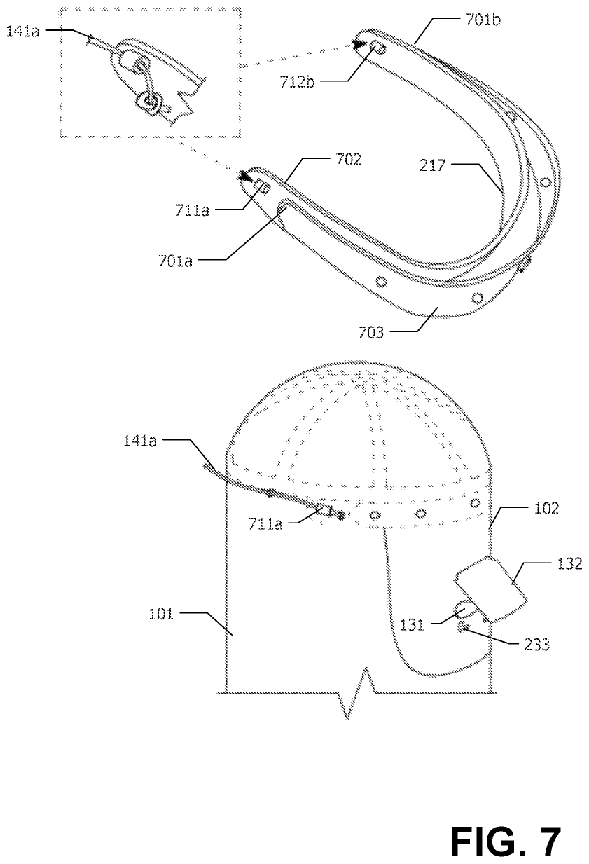

All the air filters are attached externally to the veil 101 to allow an exchange of air between the inside of the veil about the user and the outside environment. Other components of the mask 100 are described in more detail in references to figures below. a headband 217 composed of fused inner 702, as shown in FIG. 7, band and outer 703, as shown in FIG.-7, band, then coupled to the Veil 101 which in turn is also permanently fused to the face shield 102, a crown support cap 211 with its sectional parts 601, 602, and 605, as shown in FIG. 6, coupled to the top edge of the veil 212, as shown in FIG. 2, that spread the crown filter 111 and also acts as a head bump protection device. Having the ability of three put into a one piece unit, it is more infallible. It encapsulates and protects the head, the most susceptible and vulnerable portion of our body against an infection, specially COVID-19.

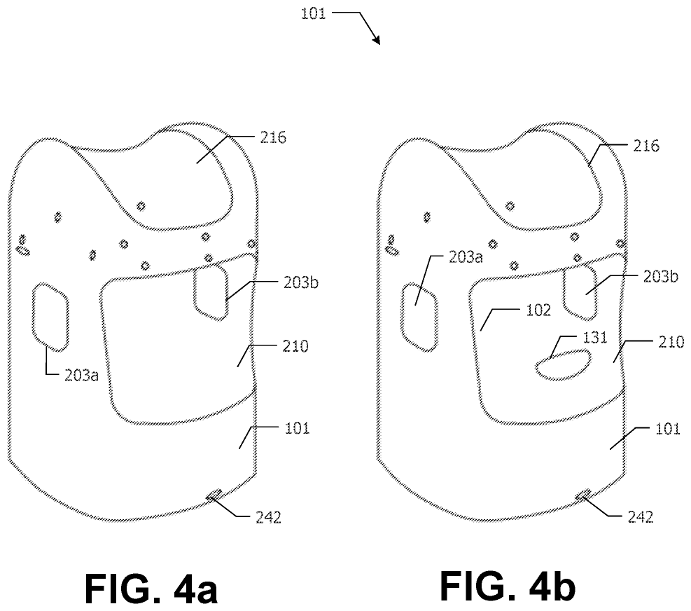

The face shield 102 is only one of the three main components of the VEILSPHERE 100. The top portion of the VEILSPHERE 100 comprises of an attached crown support cap 211 having female disc snaps 222a-n about its perimeter for coupling to the veil's crown 212. The veils crown top uses a pair of mating Velcro™ seals 213-214 to secure the crown air filter 111, as shown in FIG.-1, to a top opening 216, as shown in FIG. 4, of the crown.

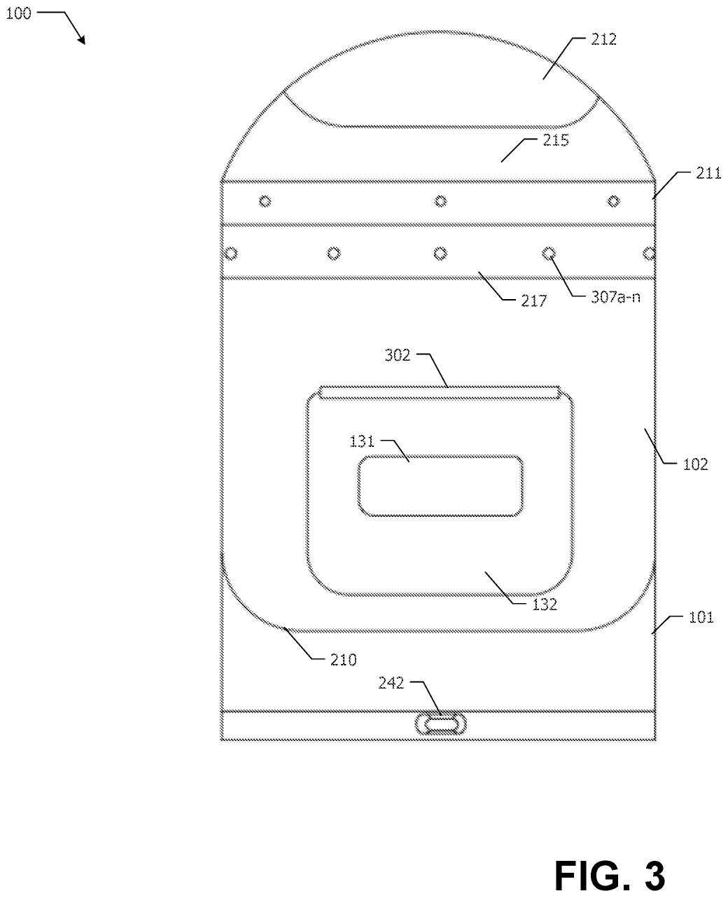

FIG. 3 illustrates a front view of an article of manufacture for providing a combination personal protection device including a mask, a shield, and a veil according to the present invention. The VEILSPHERE 100 is shown defining an outside cover of a user's head that includes a face opening that is covered by the face shield 102. The face shield 102 includes a mouth opening 131 that is covered by a mouth flap 132 attached by an upper hinge 302. The hinge 302 permits a user to raise the mouth flap 132 as needed to communicate with others and take nourishments while the VEILSPHERE 100 is in use.

The VEILSPHERE 100 has the headband 217 about its upper edge approximately in level and in front of the wearer's brow, having a set of Disc-Snap connectors 307a-n to secure the HEADBAND 217 to both the VEILSPHERE 100 and the face-shield which are fused together along the line where the headband is to be attached. The crown support cap 211 and the VEILSPHERE crown 212 are shown above the headband 217 and the crown air filter 111 is shown at the top of the entire VEILSPHERE 100.

A drawstring opening 242 is located about a bottom edge of the VEILSPHERE 100 about a centerline of the face shield 102 that allows a user to secure the entire mask to the user's head while in use

FIGS. 4a-b illustrate front side views of multiple embodiments of an article of manufacture for providing a combination personal protection device including a mask, a shield, and a veil according to the present invention. A first embodiment 401 of FIG. 4a shows the veil 101 with a face opening 210 and ear openings 203a-n. The second embodiment 402 of FIG. 4b shows the veil 101 with the face shield 102 in place and the mouth opening 131 in the face shield 102. Both embodiments show the crown air filter opening 215 and the drawstring opening 242 as described above.

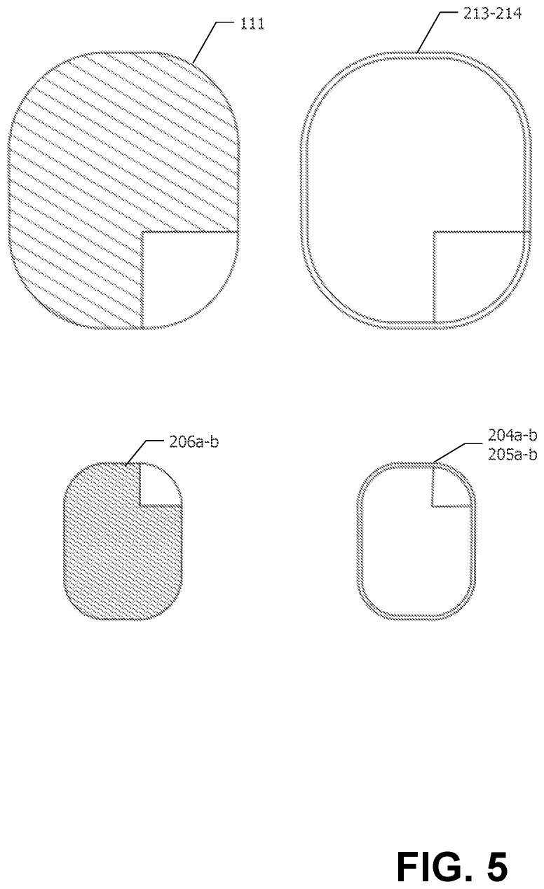

FIG. 5 illustrates a set of filter elements within an article of manufacture for providing a combination personal protection device including a mask, a shield, and a veil according to the present invention. The crown air filter 111 and a pair of mating Velcro™ seals 213-214 are shown opposite each other at the top of FIG. 5. An example of one ear air filter 206a-b and is corresponding pair of Velcro™ seals 204a-b, 205a-b are shown at the bottom of FIG. 5. Each set of Velcro™ seals are attached to outer edges of the corresponding air filter as well as the veil 101 to hold the air filters in place.

FIG. 6 illustrates a front and top view of a crown support cap 211, as shown in FIG. 2, used within an example embodiment of an article of manufacture for providing a combination personal protection device including a mask, a shield, and a veil according to the present invention. The crown support cap 211 comprises a lower ring of material 602 that fills the underside of the top of the VEILSPHERE 100 and supports the cap in place. A set of cross-cap ribs 601a-h connect the lower band of material 602 to a cap center 605. A The set of disc snap fasteners 222a-h are positioned along the lower ring of material 602 adjacent to the cross-cap ribs 601a-h. The set of disc snap fasteners 222a-h, as shown in FIG. 2, are used to secure the crown support cap 211 to a top edge of the VEILSPHERE 100.

The crown support cap 211, as shown in FIG. 2, is the supporting dome structure under the crown air filter 111, as shown in FIG. 1, so the filter won't sag and be stretched to its widest for optimum filtering potential. The spaces between the cross-cap ribs 601a-h are designed to give sufficient clearance for the exhaled air and inner heat to rise up and flow out through the crown air filter 111, as shown in FIG. 1, and be disperse fast. At the same time, the crown support cap 211 also serves as a head protection device. Its lower ring or rim 601 is mounted inside the VEILSPHERE 100. The VEILSPHERE 100 does not cover all of the crown support cap 211. The crown support cap 211 has an opening fit for the crown air filter 111.

The VEILSPHERE 100 wraps around the base or rim 602 of the crown support cap 211 where the disc snap fasteners 211a-h joins them both. The VEILSPHERE 100 goes a little higher up where it meets the crown air filter 111. The crown air filter 111 is spread over and on top of this cap and is attached to the VEILSPHERE 100 by a pair of mating ring shaped Velcro™ strips 213-214.

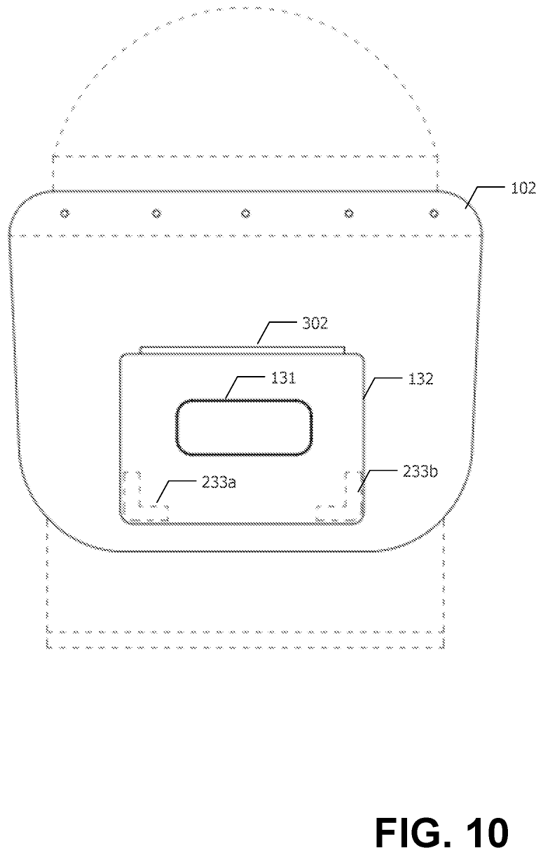

FIG. 7 illustrates partial side views of a fixed face shield 102 attaching to of an article of manufacture for providing a combination personal protection device including a mask, a shield, and a veil according to the present invention. The headband 217 once attached to the fused face shield and VEILSPHERE 100 is set for mounting on the brow of the user. The headband 217 is comprised of inner band 702 to fit on the user's brow and an outer band 703 to extend the face shield 102 forward to give comfortable space between the user's face and the face shield 102. Bands 702 and 703 are both coupled and permanently fused together at a pair of fixed joints 701a-b. The headband is attached to the fused face shield and VEILSPHERE 100 by a set of disc snaps 307a-n, as shown in FIG. 3, mounted only on band 703, as shown in FIG. 7. The drawstring or headband strap 141a and 141b are shown exiting the VEILSPHERE 100 at exit holes 801a and 801b their internal ends are each connected to the anchor blocks 711a and 711b. Once the two external ends of the strap are pulled tightly and secured outside at the rear of the VEILSPHERE 100 to pull the headband to clamp on the user's brow snugly. The mouth flap, as shown in FIG. 10, positioned over the mouth opening 131 are shown for reference.

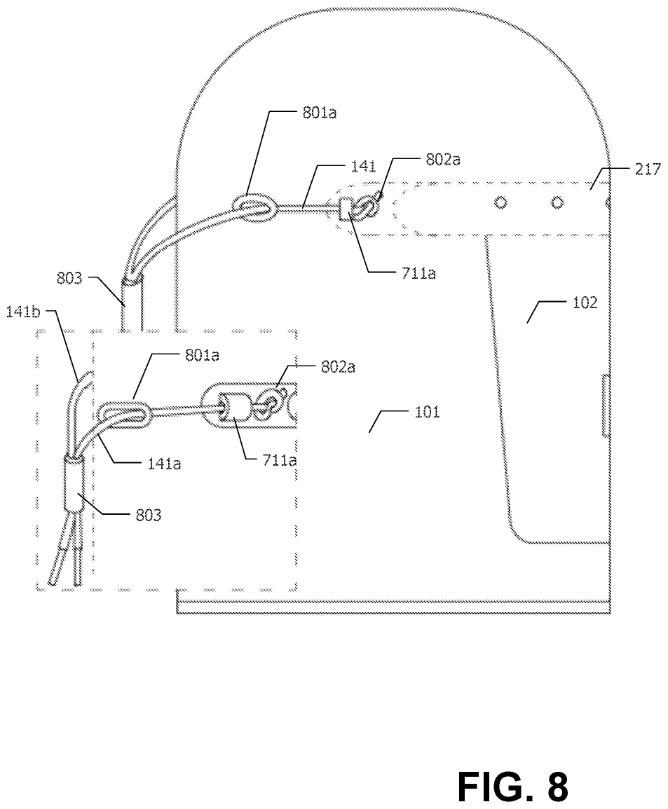

FIG. 8 illustrates a side view an example embodiment of an article of manufacture for providing a combination personal protection device including a mask, a shield, and a veil according to the present invention. The headband 217 is inside the VEILSPHERE 100. The headband 217 is attached to the inside surface of the VEILSPHERE 100 by a set of disc snap fasteners 901a-e. The headband 217 has two headband straps referred to as a right strap 141a and a left strap 141b. A right strap internal end 802a is attached to the right anchor block 711a built on the end of a right temple tip of the headband 217. The left strap internal end 802b (not shown) is attached to the left anchor block 711b built on the left temple tip of the headband 217. The two opposite ends of the straps are then individually exited out of these two exit holes 802b on the right side and a second exit hole 801b (not shown) on the left side to be joined together by a sliding drawstring coupler tubing 803 outside of the VEILSPHERE 100.

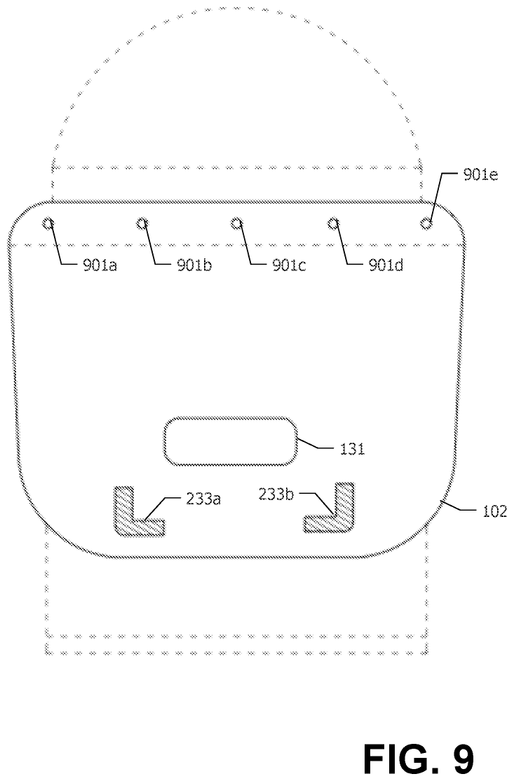

FIG. 9 illustrates a front view of a shield that is part of an article of manufacture for providing a combination personal protection device including a mask, a shield, and a veil according to the present invention. The face shield 102 is shown along with its mouth opening 131 and a pair of Velcro™ seals 233a-b that secure the mouth flap 132 in place. A set of connection openings 901a-e are shown along a top edge of the face shield 102 that are used to couple the face shield 102 to the headband 217 by the disc snaps. The Pairs of Velcro Strips 233a-b are sandwiched between the Face Shield 102 and the Mouth Flap 132 is both designed for air sealing and locking. The then the lengths of the Velcro strips should be lengthened to provide a clinically sufficient air flow seal between the mouth flap 132 and the face shield 102. Additional sealing structure similar to the air filter seals 204a-b, 206a-b may be used on the face shield 102 and the rims of the mouth flap 132.

FIG. 10 illustrates a front view of a shield and mouth opening cover that is part of an example embodiment of an article of manufacture for providing a combination personal protection device including a mask, a shield, and a veil according to the present invention. The face shield 102 is shown in FIG. 10 with the mouth flap 132 in place. The mouth flap 132 attaches to the face shield 102 by a hinge 302 across a top edge of the mouth flap 132. The pair of Velcro™ seals hold a bottom edge of the mouth flap 132 securely against the face shield 102. A user may lift the mouth flap 132 to expose the mouth opening 131 in the shield 102 by pulling the lower edge of the mouth flap 132 away from the face shield 102 to detach the mating Velcro™ shields 233a-b from each other and pivoting the mouth flap 132 upward about the hinge 302.

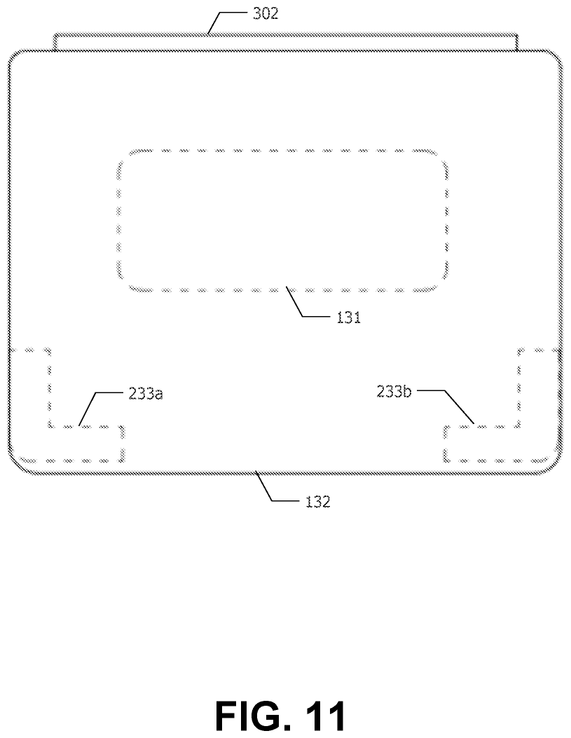

FIG. 11 illustrates a front view of a mouth opening cover that is part of an article of manufacture for providing a combination personal protection device including a mask, a shield, and a veil according to the present invention. The mouth flap 132 is shown in detail in FIG. 11. The hinge 302 is shown across the top. The positions of the mouth opening 131 and the pair of Velcro™ shields 233a-b are also shown in the relative position about the mouth flap 132.

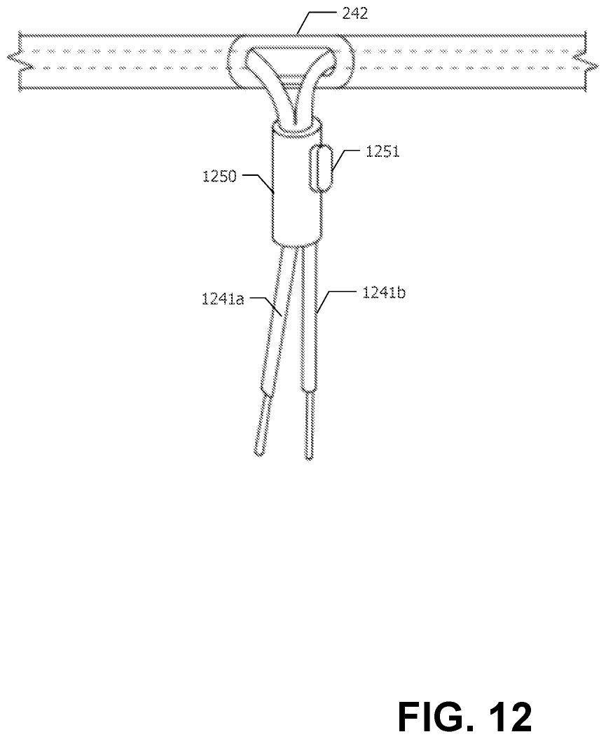

FIG. 12 illustrates a front view of shield tie that is part of an article of manufacture for providing a combination personal protection device including a mask, a shield, and a veil according to the present invention. The drawstring ends 1241a-b is shown exiting a drawstring opening 242 and having a sliding drawstring coupler 850 that securely holds ends of the drawstring 1241a-b together. A release button 1251 on the sliding drawstring coupler 1250 releases the grip on the pair of drawstring ends allowing the sliding drawstring coupler 1250 to slide up and down the length of the drawstring 1241a-b. In FIG. 12 when drawstring end 1241b is first inserted into the hole 242 of the hem which act like a tunnel, its opposite end 1241a is held outside the hem. The end 1241b is wormed into and inside the hem which wraps around the wearer's neck region until the drawstring is exited on the same hole 242 where it was initially inserted and then once outside, both ends are joined together in a clasp.

The drawstring 1241a-b works similar to the drawstring in most household trash bags. When pulled, the drawstring 1241a-b tightens the VEILSPHERE 100 around the neck of the user. However, the drawstring 1241a-b should have a limited strength, just sufficient to tighten the VEILSPHERE 100 but easily be broken by a child.

Even though particular combinations of features are recited in the present application, these combinations are not intended to limit the disclosure of the invention. In fact, many of these features may be combined in ways not specifically recited in this application. In other words, any of the features mentioned in this application may be included to this new invention in any combination or combinations to allow the functionality required for the desired operations.

No element, act, or instruction used in the present application should be construed as critical or essential to the invention unless explicitly described as such. Further, the phrase “based on” is intended to mean “based, at least in part, on” unless explicitly stated otherwise.

What is claimed is:

1. An article of manufacture for providing a combination personal protection device including a mask, a shield, and a veil, the personal protection device comprises:
a mask;
a veil having a face opening and a pair of ear openings;
a face shield having a mouth opening;
a mouth flap configured to removably cover the mouth opening; and
a headband having a pair of bands coupled together, an outer band of the pair of bands being coupled the veil by attachment clips.

2. The personal protection device according to claim 1, wherein the personal protection device further comprises:
a crown support cap coupled to a top edge of the veil;
a crown air filter and a pair of ear air filters.

3. The personal protection device according to claim 2, wherein the crown air filter is coupled to the top edge of the veil by a pair of mating Velcro seals.

4. The personal protection device according to claim 2, wherein each one of the pair of ear air filters are coupled to the veil by a pair of ear mating Velcro seals.

5. The personal protection device according to claim 2, wherein the crown support cap is coupled to the veil by a set of disc snap fasteners.

6. The personal protection device according to claim 2, wherein the face shield is coupled to the headband by a second set of disc snap fasteners.
